(19) United States
(12) Patent Application Publication
(10) Pub. No.: US 2011/0296498 A1
(43) Pub. Date: Dec. 1, 2011

(54) Fax authentication for secure fax transmission and of unwanted faxes

(75) Inventors: Sahadevasangary Gajadevasangary, Stevenage (GB); Martin Roantree, Brookmans Park (GB); Alex Cheshire, St. Albans (GB); Maysara Fermawi, Borehamwood (GB); Joanna Keep, Stevenage (GB)

(73) Assignee: Xerox Corporation, Norwalk, CT (US)

(21) Appl. No.: 12/789,501

(22) Filed: May 28, 2010

(51) Int. Cl. G06F 21/00; G06F 3/12

(52) U.S. Cl. 726/4; 358/1.15; 358/468; 726/3

(57) ABSTRACT

A system and a method of authenticating faxes are disclosed. The method includes receiving image data that includes at least one page to be transmitted by a sending fax device. An authentication code is generated at the sending fax device. The authentication code is transmitted to a receiving fax device. The receiving fax device determines whether the authentication code is one which is accepted. If it is, the receiving fax device authorizes commencement of the fax transmission.

### BACKGROUND

The embodiments described herein relate generally to facsimile machines, also known as fax machines, or multifunction machines which incorporate them, and more particularly to a system and method of processing incoming and outgoing faxes.

Faxing information has proven to be a simple and useful way of sending the information across long distances, while ensuring the integrity of the information being sent. As a result, a large number of faxes are sent and received daily. Each fax contains the information to be printed by the receiving fax device (the image data) as well as address information which the user, or the fax device itself, can enter in various prescribed fields. In addition to a field which is used to uniquely identify the receiving fax device (e.g., by its telephone number) other fields are also provided. These sub-address fields allow, for example, the sender to specify a destination sub-address box at the receiving fax device where the incoming fax will be stored or to send a password for accessing the fax at the receiving fax device. The use of the sub-address fields is optional and thus they are generally left empty.

An Internet facsimile (I-Fax) apparatus is one example of a fax device and is provided with functions of converting image data to a file and transmitting/receiving it over a computer network, a typical example of which is the Internet. The Internet facsimile apparatus is capable of carrying out usual facsimile communications over a Public Switched Telephone Network (PSTN), and therefore it also can function as apparatus connected between a computer network and PSTN.

It is known that fax communications, like all technologies, have security risks. This can be at least partially resolved by establishing policies around the use of fax machines. By creating a set of standard operating procedures (SOP) around the use of secure faxes, most of the problems involved can be mitigated. However, one problem which remains is that the fax document does not sometimes reach its intended destination or, if it does, may be seen by other than its intended recipient. It is also possible to receive unwanted fax transmissions known as “junk faxes”. As a result, the level of security and assurance of integrity for the fax transmission can be compromised.

Thus, it is desirable therefore to establish a fax protocol that improves the integrity and confidentiality of information transmitted by the fax transmission.

### INCORPORATION BY REFERENCE

The following references, the disclosures of which are incorporated herein in their entireties by reference, are mentioned:

U.S. Patent Application Publication No. 2004/0051899, entitled IMAGE PROCESSING DEVICE AND AUTOMATIC PRINTING RESTRICTION AND CONTROL METHOD AND DOCUMENT RECEPTION CONTROL METHOD, published on Mar. 18, 2004, to Saitoh, et al., discloses an automatic printing restriction and control method for an image processing device that comprises a facsimile communication unit capable of handling plural communication methods including facsimile communications via Internet, and prints out documents received by the facsimile communication unit. The method includes presetting whether or not automatic printing of received documents is to be implemented, separately with respect to each of the plural communication methods, and restricting and controlling implementation of automatic printing of received documents in accordance with the settings.

U.S. Patent Application Publication No. 2009/0083366, entitled SECURE DOCUMENT TRANSMISSION, published on Mar. 26, 2009, to Roantree, et al., discloses a method and apparatus which transmits an item that is in electronic form over multiple networks. The method begins by receiving the item that is to be electronically transmitted. The method separates the item into at least a first fragment and a second fragment, transmits the first fragment over a first network to a receiving device, and transmits the second fragment over a second network to the receiving device. After the receiving device receives all the different fragments, it combines the first fragment and the second fragment to reproduce the item.

U.S. Patent Application Publication No. 2009/0086277, entitled METHOD AND APPARATUS OF ADDING PAGES TO AN IMAGE DATA FILE TO BE SENT OVER A NETWORK, published on Apr. 2, 2009, to Cheshire, et al., discloses sending an image data file over a network. An image data file that includes a plurality of pages is sent from a first device to a second device, wherein at least one substitute or additional page of image data may be included in the image data file.

U.S. Pat. No. 7,623,257, entitled METHOD FOR HANDLING FAXES BY A FAX MACHINE, which issued Nov. 24, 2009, to Chase, et al., discloses a method of handling faxes by a fax machine. The method includes generating user-configured rules, each user-configured rule including a corresponding fax job condition and an associated fax machine action to be performed if the corresponding fax job condition is met. A user-configured policy is generated for handling faxes in a fax job including the user selecting the user-configured rules to be applied when the user-configured policy is applied and the user ranking the user-configured rules from a highest rank to a lowest rank. A fax machine receives a fax job and applies the user-configured policy to the fax job by applying the user-configured rules in an order of application from the highest ranked rule to the lowest ranked rule.

### BRIEF DESCRIPTION

In accordance with one aspect of the embodiments described herein, there is provided a method of authenticating faxes that includes receiving at least one page to be transmitted by a sending fax device and generating an authentication code at the sending fax device. The authentication code is transmitted to a receiving fax device. Whether the authentication code is one which is accepted by the receiving fax device is identified. If accepted, authorization of commencement of the fax transmission of the at least one page from the sending fax device to the receiving fax device is provided.

In accordance with another aspect of the embodiments described herein, a system for authenticating faxes includes a first fax device coupled to a fax transmission network. The first fax device includes a memory for receiving at least one page to be transmitted by the first fax device. A generating component is configured to generate an authentication code and send it to a second fax device coupled to the fax transmission network. A retaining component of the first fax device holds the at least one page until confirmation that the authentication code is accepted is received from the second fax device.

In accordance with another aspect, a method of authenticating faxes includes, at a receiving fax device, receiving a request from a sending fax device for transmission of at least one page transmitted over a fax transmission network. An authentication code is requested in response to the request for transmission from the sending fax device. If the authentication code is received from the sending fax device and is accepted, transmission of the at least one page is authorized.

### BRIEF DESCRIPTION OF THE DRAWINGS

FIG. 1 is a diagrammatic view of a system including a first fax device connected by a fax transmission network to a second fax device;

FIG. 2 illustrates aspects of the system of FIG. 1 in greater detail; and

FIG. 3 is a flow chart illustrating a method for processing fax jobs in accordance with another embodiment.

### DETAILED DESCRIPTION

Embodiments herein provide systems and methods for generating an authentication code which enable a sending fax device to withhold an outgoing fax, pending authorization. Once a receiving device receives a request from the sending device to fax pages, the receiving device requests transmission of an authentication code from the sending device. The authentication code is generated at the sending device using an authentication algorithm. The pages of the fax are held at the sending device while the authentication code is submitted and, if the authentication code is accepted by the receiving device, the receiving fax device authorizes transmission of the fax and the sending fax device transmits the pages of the fax.

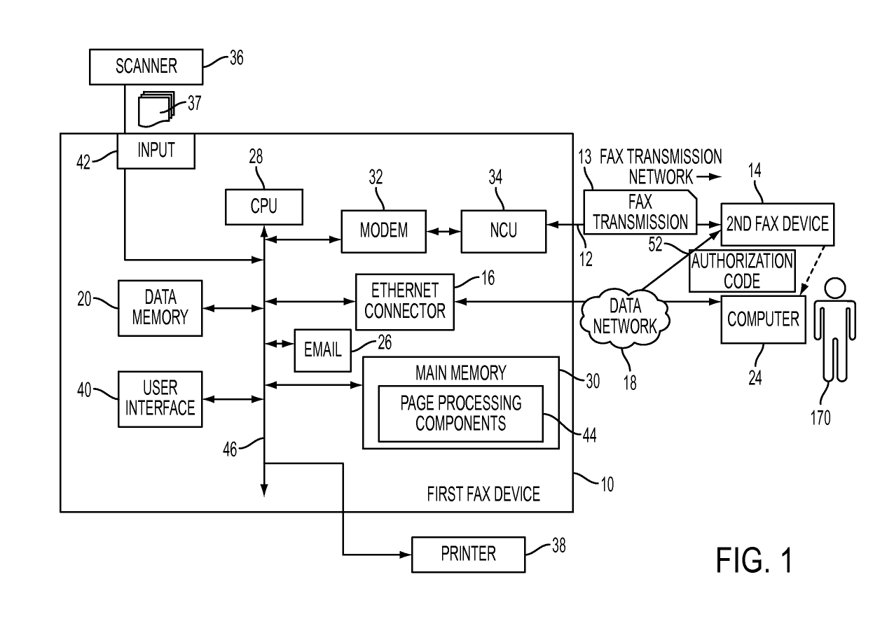

Referring to the drawings, FIG. 1 is a schematic depiction of a fax system which includes a first fax device 10. The first fax device 10 is connected to a fax transmission network (FTN) 12, for sending image data in the form of a facsimile (fax) 13, to one or more other (second) fax device(s) 14 via the FTN 12. FTN 12 can be, for example, a Public Switched Telephone Network (PSTN), a Fax over Internet Protocol (FoIP), or other network suitable for transmission of faxes. The process of sending and/or receiving faxes is referred to herein as a fax job.

The first fax device 10 may also include a network connection 16, such as an Ethernet connection, for connecting the first and second devices 10, 14 via a data transmission network 18. Of course, there may be many more than two fax devices capable of sending and/or receiving authenticated faxes between them. The network 18 may be a digital network such as a local area network (LAN), a wide area network (WAN), the Internet or Internet Protocol (IP) network, broadband networks, e.g., PSTN with broadband technology, VoiceOver IP, WiFi network, other networks or systems, or a combination of networks and/or systems.

The first fax device 10 includes data memory 20 for storing incoming faxes and for storing image data files which are to be transmitted via fax.

The fax device 10 can include email functionality 26 for sending email messages to remote computers 24, such as personal computers, via the data network 18. An electronic form of faxes can be sent over the data network 18, for example, by compressing the fax image data, converting it to a TIFF file and text-coding the TIFF file, then adding it to the data section of e-mail in accordance with such as MIME (Multipurpose Internet Mail Extensions) and transmitting/receiving it as an e-mail.

The first fax device 10 includes a digital processor 28, such as a Central Processing Unit (CPU), for controlling the functionality of the fax device in a centralized manner, including handling fax jobs in the manner as described herein. The digital processor 28 can be variously embodied, such as by a single-core processor, a dual-core processor (or more generally by a multiple-core processor), a digital processor and cooperating math coprocessor, a digital controller, or the like.

The first fax device 10 also includes memory 30 for storing the programming suitable for carrying out fax job functions. The memory 20,30 may represent any type of tangible computer readable medium such as random access memory (RAM), read only memory (ROM), magnetic disk or tape, optical disk, flash memory, or holographic memory. In one embodiment, the memory 30 may include a combination of random access memory and read only memory. In some embodiments, the processor 28 and memory 30 may be combined in a single chip.

The first fax device 10 also includes a modem 32 or other device suitable for connecting to the FTN 12 for sending and receiving faxes. The modem 32 is operable for modulating and demodulating a facsimile protocol signal and image signal. In the case of a PSTN network 12, a Network Coupler Unit (NCU) 34 may connect the fax device 10 to a telephone line to make an outgoing call to and receive an incoming call from a phone line in the PSTN 12 and to interface analog signals. In FoIP network, the NCU 34 is not required.

A source 36 of image data 37 is in communication with the first fax device. For example first fax device 10 can include or communicate with a scanner 36 for scanning documents to form electronic representations of the images thereof which can be sent in the form of faxes in a fax job. It is to be appreciated that the image data can be input from any suitable image source 36, such as a workstation, database, memory storage device, such as a disk, or the like. Typically each input digital image page includes image data for an array of pixels forming the image.

The first fax device 10 can also include or communicate with a printer 38 for forming printed images of received faxes, among other things, on sheet material such as paper. Suitable printers include electro-photographic printers, ink-jet printers, including solid ink printers, thermal head printers that are used in conjunction with heat sensitive paper, and other devices capable of marking an image on a substrate.

The first fax device 10 may also include a user interface 40 which can include a display screen and a control panel that enable a user to operate the fax device. The user interface 40 may provide a Graphic User Interface (GUI) displayable on the screen. The user interface 40 can be used to program the functionality of the fax device for processing faxes in the manner as described below. In other embodiments, the fax device may also be operated or programmed remotely via computer 24 connected to the fax device 12 by the data network 18.

The first fax device 10 includes an input device 42, which is configured to receive an image data file from source 36. As an alternative to a scanner, the image data can be input from any suitable image source 36, such as a workstation, database, memory storage device, such as a disk, or the like. Typically, each input digital image includes image data for an array of pixels forming the image. The image data may be photographs, video images, combined images which include photographs along with text, and/or graphics, or the like. The image data may be received in JPEG, GIF, JBIG, BMP, TIFF or other common filed format used for images and which may optionally be converted to another suitable format prior to processing. In an exemplary embodiment, the image data file comprises a plurality of pages to be transmitted by the first fax device 10.

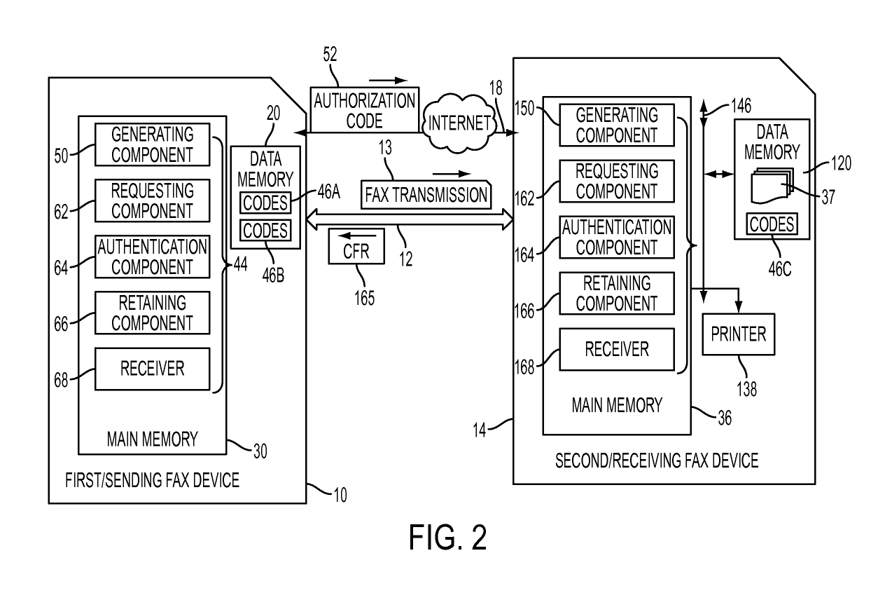

The fax device 10 includes fax processing components 44, for implementing the methods described herein and which may be implemented in hardware or a combination of hardware and software. In the embodiment illustrated in FIG. 1, the components 44 are in the form of software instructions stored in memory 30, which are executed by processor 28. These components 44 are described in greater detail with reference to FIG. 2.

The various components 16, 20, 26, 28, 30, 32, 34, 48, 40, 42 of the fax device 10 may communicate via a data/control bus 46.

The second fax device 14 may be similarly configured to the first device. However, in some embodiments, the devices 10, 14 may be somewhat different. For example, the first fax device may be configured for sending but not receiving faxes. Additionally, the components 44 need not be identical.

Fax or facsimile machines disclosed herein are merely exemplary and embodiments of the disclosure may be practiced with other systems having fax capabilities (e.g., a computer, a fax server/gateway, personal digital assistant (PDA), cell phone, etc.). In addition, in an embodiment, the fax devices or first device 10 may comprise or may be part of another machine or device such as a multifunction printing device MFP or MFD) that includes multiple capabilities such as printing, scanning, faxing, and/or copying. In an embodiment, first device 10 may comprise a PC, or other device for sending and receiving faxes. Other machines and devices may also be used as long as they are capable of handling electronic image data.

The fax transmission protocol used can be any standard protocol. The International Telecommunication Union Telecommunications Standardization Sector (ITU or ITU-T), based in Geneva, Switzerland, coordinates telecommunication standards and protocols, including facsimile transmission. The ITU, for example, identifies the standards, characteristics, and operation for facsimile devices of Group 3 and Group 4 digital transmission. Group 3 (G3) fax technology is currently the most widely used type of facsimile transmission. Group 4 (G4) faxes are designed to operate over digital circuits; specifically, G4 operates on a 64 Kbps ISDN (Integrated Services Digital Network) B Channel. Unlike Group 3 faxes, the digital scan information if not converted into an analog signal, rather it is transmitted digitally.

In general, G3 fax technology uses digital modulation combined with amplitude and phase modulation of an analog signal (generated by modems). Typically data is compressed using digital compression methods and encoding is then used to communicate image data over analog telephone lines with a result of a reduced transmission time of less than one minute per page. There is an exchange of DIS/DSC (CSI,DIS/TSI,DCS) messages. Digital Identification Signal (DIS) is the initial message stating the capabilities of the receiving device. The information helps the sending device 10 to know the characteristics of the called receiving device 14 and decide the capabilities parameters to be employed for the transmission. Called Subscriber Identification (CSI) is an optional signal which may be used to provide the specific identity of the called receiving device by its international phone number. Transmitting Subscriber Identification (TSI) is an optional signal which indicates the identification of the sending device. It may be used to provide additional security to the fax transmission process. Digital command signal (DCS) defines the transmit parameters and starts an image transfer sequence. The accompanying TSI frame has the phone number.

FIG. 2 illustrates aspects of the exemplary system for processing faxes. In particular, the components 44 are shown, and some of the components of the devices 10, 14 shown in FIG. 1 are omitted for clarity. Similar components of the second fax device 14 are accorded the same numbers as for the first fax device, incremented by 100. It is appreciated a fax device can be both a sending and receiving device.

The first fax device 10 includes a generating component 50, which is configured to generate an authentication code 52. The authentication code is a short piece of information used to authenticate the sending fax device as the sender of the fax transmission 13. The authentication code may be generated using an authentication algorithm. The authentication code may be, for example, any combination of digits, for example, at least six or at least eight digits. The algorithm may use pre-loaded authentication information, e.g., a set of a large number, e.g., at least one hundred eight character authentication codes 46A for sending faxes to a first receiving fax device, a different set of one hundred eight character authentication codes 46B for sending faxes a second receiving fax device, and so on. These sets of codes 46A, 46B, etc., are stored in memory and are identifiable by a receiving fax device with authentication capability such as, other same family fax devices. Alternatively, each fax device has one set of codes which are recognizable by a set of other fax devices as associated with that fax device. The second fax device 14 can include an analogous generating component 150 and unique set of codes 46.

In one embodiment, the authentication code generator 50 may draw the codes in sequence from the set 46A, for example, when sending to fax device 14. When all the codes are used up, the generator 50 starts at the beginning again. In another embodiment, the authentication code generator 50 draws codes at random from the set 46A. In another embodiment, the algorithm applies a predetermined permutation to the code which is based, for example, on the calendar day on which the fax is being sent. The sets of codes 46 may be preloaded onto the fax devices 10, 14 when they are installed in their respective locations. To allow for additional fax devices to participate later, the preloaded codes 46A,46B, etc. may include sets for fax devices which do not yet exist. In another embodiment, the codes may be changed periodically by uploading a new set of codes to the memory. In yet another embodiment, there may be no preset codes 46. The generator's algorithm is configured for generating the different authentication codes 52 according to a predetermined routine, which can be recognized by the second fax device as having been generated by the first fax device.

The second fax device 14 includes a requesting component 162 configured to request an authentication code 52 from the sending/first fax device 10. The second fax device 14, once receiving a request from the sending device 10 to fax pages, makes the request for the authentication code 52. The first fax device 10 can include an analogous requesting component 62. The receiving fax device blocks receipt of the pages until an authentication code 52 is submitted to the receiving fax device 14 and an acceptance has been sent to the sender device 10.

The second fax device 14 also includes an authentication component 164 configured to identify whether the authentication code sent by the first fax device is one which is accepted by the receiving device 14 and to authorize the sending of a confirmation for receipt (CFR) 165 to the first fax device 10, which indicates that the second fax device 14 will receive the faxed pages when they are sent. The authentication code is identified, for example, using an authentication algorithm, a look up table, or other data structure. The algorithm may use the information provided by pre-loaded authentication codes, as described previously. The first fax device 10 can include an analogous authentication component 64. The request for the authentication code and the authentication code 52 itself can be sent via the fax communication network 18 or via the data network 18. In the latter case, different modes may be used for the fax and authentication code (e.g., PSTN and internet transmission modes).

The first fax device 10 may also include a retaining component 66 configured to hold the at least one page until confirmation that the authentication code is accepted is received from the second/receiving device 14. The second fax device 14 can include an analogous retaining component 166.

The second fax device 14 includes a receiver component 168 configured to receive at least one page 37 in the fax transmission 13, and store the at least one page in data memory 120, pending printing. The first fax device 10 can include an analogous receiver component 68.

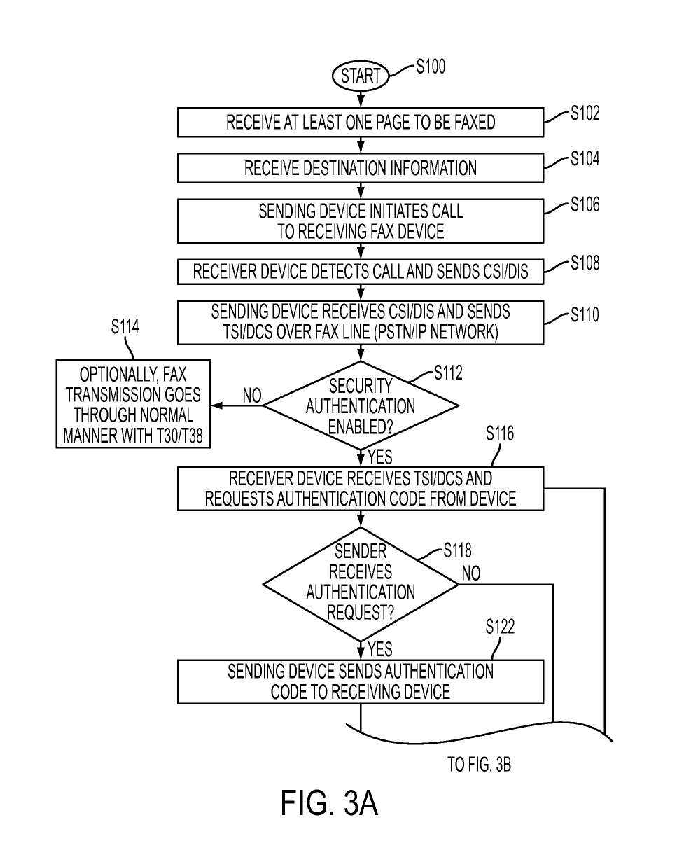

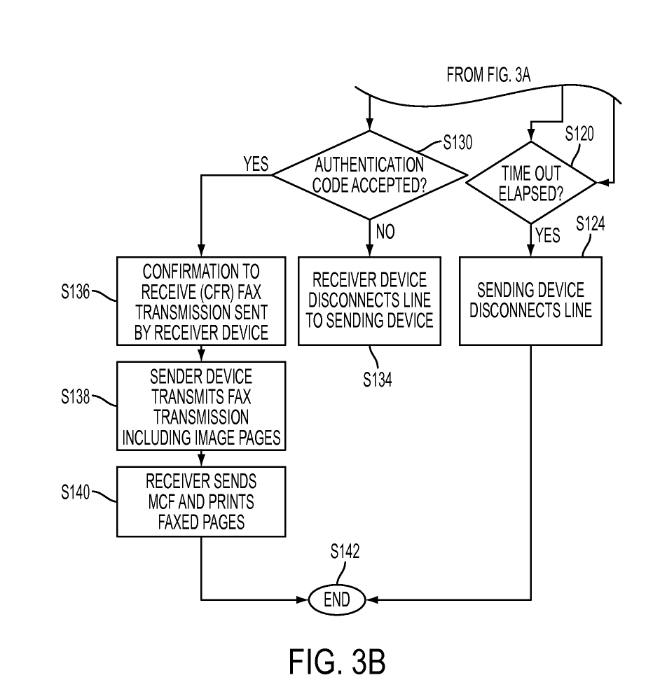

FIG. 3 is a flowchart illustrating a method of authentication of faxes in a system such as that shown in FIGS. 1 and 2. The method begins at S100.

At S102, at least one page which is to be transmitted as a faxed image page is received by the first fax device 10.

At S104, a user may be prompted to enter address related information for a second fax device 14, such as its telephone number or IP address, to which the fax is to be transmitted.

At S106, the sending fax device 10 initiates a call to the receiving fax device.

At S108, the receiving fax device 14 detects the call and may send a CSI/DIS signal. The CSI (Called Subscriber Identification) is the receiving fax device's id and the DIS (Digital Identification Signal) is the fax capabilities of the receiving device.

At S110, the sending device 10 receives the CSI/DIS signals and may send TSI/DCS signals over the fax transmission line 18 (PSTN/IP network) to the receiving device 14. The TSI (Transmitting Subscriber Identification) is the id of the sending fax device 10. The DCS (digital command signal) is the sending device's response to the DIS. It informs the receiving device 14 what type of modem modulation signal and what type of coding and resolution will be used by the sending device 10.

If at S112, the receiving fax device 14 is security authentication enabled, the method proceeds to S116, otherwise to S114. At S114, a fax may still be accepted, without authentication.

At S116, the receiving fax device 14 receives the TSI/DCS signals and requests the authentication code from the sending fax device.

If at S118, the sending fax device 10 receives the request for the authentication code, the method proceeds to S122, otherwise to S120. The sending fax device 10 keeps the connection open for a predetermined time out period. If the time out elapses at S120 without receipt of request for an authentication code, the method proceeds to S124, and the sending device disconnects from the connection. If the authentication request is received prior to the timeout, the method proceeds to S122.

At S122, the authentication code 52 is transmitted to the receiving fax device 14 from the sending fax device 10. The code 52 may be sent over the data network 18, such as the Internet.

At S130, the receiving fax device 14 determines whether the submitted authentication code 52 is accepted. If the authentication code is not accepted, the method proceeds to S134, otherwise, to S136.

At S136, if the authentication code 52 is accepted, a confirmation to receive (CFR) 165 the fax transmission 13 is sent to the sending fax device 10 from the receiving fax device 14.

At S138, when the CFR is received by the sending fax device 10, the fax transmission 13, including image pages, is transmitted from the sending fax device 10 to the receiving fax device.

At S140, the receiving fax device sends a message confirmation fax (MCF) to the sending fax device 10 to indicate that a complete fax transmission 13 has been received. The pages 37 of the complete fax transmission 13 may be printed on the printer 138.

The method ends at S142.

In some embodiments, the fax transmission 13 may include a code which causes the fax to be held at the printer 138 until released by an intended recipient 170.

The exemplary authorization method has several advantages. First, it allows the receiving fax device 14 to screen out junk faxes, since the sender of the fax does not have the correct authentication code 52. Second, it provides assurance to the sending fax device 10 that the correct destination address has been entered, because the receiving fax device 14 requests an authentication code. If no request for authentication is received within a predetermined time period, the fax is not sent.

The exemplary fax authentication system is particularly suited to use within an organization, such as a company or government department, which operates at different locations, nationally or internationally. The fax devices 10,14, etc., may be reserved entirely for sending and receiving authenticated faxes, with other fax devices being used for unauthenticated communications with fax devices outside the organization. In another embodiment, the fax devices 10, 14, etc., may have two or more modes, e.g., an authentication mode and a normal (“unauthenticated”) mode, one mode may be a default mode and/or one or both modes may be user-selected, for example, via the user interface 40. In the normal mode, the authentication components are disabled and faxes can be transmitted and/or received without being authenticated.

The method illustrated in FIG. 3 may be implemented in a computer program product that may be executed on a computer. The computer program product may be a tangible computer-readable recording medium on which a control program is recorded, such as a disk, hard drive, or the like. Common forms of computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use. Alternatively, the method may be implemented in a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of processing a fax that is in turn capable of implementing the flowchart shown in FIG. 3, can be used to implement the method for authentication of faxes.

The term “software” as used herein is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

It will be appreciated that variants of the above-disclosed and other features and functions, or alternatives thereof, may be combined into many other different systems or applications. Various presently unforeseen or unanticipated alternatives, modifications, variations, or improvements there in may be subsequently made by those skilled in the art which are also intended to be encompassed by the following claims.

What is claimed is:

1. A method of authentication of faxes comprising:
receiving at least one page to be transmitted by a sending fax device;
generating an authentication code at the sending fax device;
transmitting the authentication code to a receiving fax device;
identifying whether the authentication code is one which is accepted by the receiving fax device; and
if the authentication code is one which is accepted by the receiving fax device, authorizing commencement of fax transmission of the at least one page from the sending fax device to the receiving fax device.

2. The method of claim 1, further comprising, after receiving the request, transmitting the at least one page to the receiving fax device.

3. The method of claim 1, further comprising printing the at least one page.

4. The method of claim 1, wherein the authentication code is generated using an authentication algorithm.

5. The method of claim 1, wherein the authentication code is identified using an authentication algorithm.

6. The method of claim 1, wherein the sending and receiving fax devices are coupled to a network selected from the group consisting of a local area network (LAN), a wide area network (WAN), a fax over internet protocol (FoIP) network, a PSTN, a WiFi network, and a combination thereof.

7. The method of claim 1, wherein the generating of the authentication code is performed by a processor of the first fax device.

8. The method of claim 1, further comprising storing the at least one page at the sending fax device until the request is received from the receiving fax device.

9. The method of claim 1, further comprising, at the receiving fax device, receiving a request from the sending fax device to fax pages and requesting the authentication code from the sending fax device in response.

10. The method of claim 1, wherein the identifying is performed by a processor of the second fax device.

11. The method of claim 1, wherein the authentication code is sent via a different transmission mode from the fax transmission.

12. The method of claim 1, further comprising, at the second fax device, blocking receipt of the fax transmission until the authentication code is accepted.

13. A computer program product comprising tangible media which encodes instructions for performing the method of claim 1.

14. A system for processing secure faxes comprising:
at least one fax device comprising memory which stores instructions for performing the method of claim 1 and a processor, in communication with the memory for executing the instructions.

15. A system for authenticating faxes comprising:
a first fax device coupled to a fax transmission network including:
memory for receiving at least one page to be transmitted by the first fax device;
a generating component configured to generate an authentication code and send it to a second fax device coupled to the fax transmission network; and
a retaining component which holds the at least one page until confirmation that the authentication code is accepted is received from the second fax device.

16. The system of claim 15, wherein the generating component is in the form of software instructions stored in memory and which are executed by a processor of the first fax device.

17. The system of claim 15, further comprising the second fax device coupled to the fax transmission network, the second fax device comprising an authentication component configured to identify whether the authentication code transmitted from the first fax device is accepted.

18. The system of claim 17, wherein at least one of the first fax device and the second fax device comprises a multi-function device.

19. The system of claim 17, wherein the first fax device communicates the authorization code via a network other than the fax transmission network.

20. The system of claim 15, further comprising a printer associated with the second fax device for printing the at least one page.

21. The system of claim 15, wherein the fax transmission network is selected from the group consisting of a local area network (LAN), a wide area network (WAN), a fax over internet protocol (FoIP) network, a PSTN, a WiFi network, and a combination thereof.

22. A method of authenticating faxes comprising:
at a receiving fax device:
receiving a request from a sending fax device for transmission of at least one page over a fax transmission network,
requesting an authentication code from the sending fax device in response to the request for transmission;
if the authentication code is received from the sending fax device and is accepted, authorizing transmission of the at least one page.

23. The method of claim 22, further comprising authenticating the authentication code using an authentication algorithm.

24. A computer program product comprising tangible media which encodes instructions for performing the method of claim 22.
